(19) United States
(12) Patent Application Publication
(10) Pub. No.: US 2012/0109900 A1
(43) Pub. Date: May 3, 2012

(54) MARKETIZATION ANALYSIS

(75) Inventors: Ali Raza Sahibzada, Bellevue, WA (US); Michael Joseph Eatherly, Puyallup, WA (US)

(73) Assignee: MICROSOFT CORPORATION, Redmond, WA (US)

(21) Appl. No.: 12/939,046

(22) Filed: Nov. 3, 2010

(51) Int. Cl. G06F 17/30

(52) U.S. Cl. 707/687; 707/758; 707/E17.005

(57) ABSTRACT

Various embodiments provide techniques for analyzing the marketization of products. In at least some embodiments, a marketized version of a product (e.g., a software application) is associated with a configuration file that indicates actual product element settings for the marketized version. According to some embodiments, techniques are provided for determining if the product element settings (e.g., expected behaviors) indicated in the configuration file match product element settings in a specification for the product and/or vice-versa. In at least some embodiments, techniques are provided for generating a specification file from a configuration file for a marketized version of a product. For example, product elements and product element settings can be selected from the configuration file and used to generate the specification file. The specification file can then be used to validate the product and/or other versions of the product, e.g., subsequent builds and/or marketizations of the product.

### BACKGROUND

Products that are released are often associated with a number of different versions that each targets a specific market. For example, a software product can have a number of different versions, with each version being configured for a specific market. Markets can be divided based on geographic location, language, political divisions, demographics, and so on. This aspect of the product cycle is often referred to as marketization. During the marketization of a product, product features can be enabled, disabled, or customized for a particular market.

For example, consider a scenario where a product such as a web browser has a utility for finding schedules for public transportation. In a particular market that has little or no public transportation, this utility can be considered extraneous and thus can be disabled or customized for a different purpose as part of the marketization of the web browser.

To aid in the marketization process, some products are associated with a marketization specification that indicates marketization settings for elements of a product. Elements of a product can include features of the product such as graphical elements, utilities, subroutines, and so on. The marketization specification can indicate that a particular element is to be enabled, disabled, or customized for a particular market. When a marketized version of the product is created for a particular market, the marketization specification can be followed to configure the elements of the product for the particular market.

Due to the complexity of many products and the marketization process itself, errors can be made during marketization. For example, a particular product element that is indicated by a marketization specification to be disabled can be inadvertently enabled in a marketized version of the product. Additionally, hyperlinks that are included as part of the product may be broken or may cause the product to navigate to a wrong location, such as a wrong web page.

Detecting errors in a marketized version of a product can be time and labor intensive. For example, a worker may manually check all elements of a product (e.g., a publically-released version of the product) against the marketization specification for the product to see if any of the elements are not set according to the marketization specification.

Additionally, some products may not have a marketization specification or other organized collection of marketization data. Generating a marketization specification for a product can be time-consuming and error-prone. For example, to generate a marketization specification for a product, a worker may go through each element of a product and manually indicate in the specification the settings for each element, e.g., enabled, disabled, or customized.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques for analyzing the marketization of products. In at least some embodiments, a marketized version of a product (e.g., a software application) is associated with a configuration file that indicates actual product element settings for the marketized version, e.g., a product build for a particular market. According to some embodiments, techniques are provided for determining if the product element settings in the configuration file match product element settings in a specification for the product and/or vice-versa. For example, a specification file for a particular product can indicate that a text element of a user interface for the product is to be disabled in a marketized version of the product.

In at least some embodiments, techniques are provided for generating a specification file from a configuration file for a marketized version of a product. For example, product elements and product element settings can be selected from the configuration file and used to generate the specification file. The specification file can then be used to validate the product and/or other versions of the product, e.g., subsequent builds and/or marketizations of the product.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example user interface in accordance with one or more embodiments.

FIG. 3 illustrates an example user interface in accordance with one or more embodiments.

FIG. 4 illustrates an example settings table in accordance with one or more embodiments.

FIG. 5 illustrates an example analysis table in accordance with one or more embodiments.

FIG. 6 illustrates an example user interface in accordance with one or more embodiments.

FIG. 7 illustrates an example element settings region in more detail in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 is a flow diagram that describes steps in a method in accordance with one or more embodiments.

FIG. 11 is a flow diagram that describes steps in a method in accordance with one or more embodiments.

FIG. 12 is a flow diagram that describes steps in a method in accordance with one or more embodiments.

FIG. 13 illustrates an example system that can be used to implement one or more embodiments.

### DETAILED DESCRIPTION

### Overview

Various embodiments provide techniques for analyzing the marketization of products. In at least some embodiments, marketization refers to the process of configuring a product (e.g., a software application) for a particular market. Markets can be divided based on geographic location, language, political divisions, demographics, and so on. Configuring a product for a particular market can include configuring elements of the product (e.g., graphical elements, utilities, subroutines, hyperlinks, and so on) for the particular market. In at least some embodiments, configuring elements of a product for a particular market can include configuring market-specific content such as date/time formats, currency formats, first name and last name order, and so on for the particular market.

According to some embodiments, a product can be associated with a specification that indicates how product elements should be set for particular markets. For example, the specification can indicate for a specific market that a particular element should be enabled, disabled, customized, and so on.

In at least some embodiments, a marketized version of a product includes a configuration file that indicates actual product element settings for the marketized version, e.g., the product build for a particular market. In an ideal scenario, the element settings in the configuration file would match corresponding element settings indicated in the spec. Mistakes can be made, however, during the marketization of a product that can cause a product element setting in a configuration file to differ from a corresponding product element setting indicated by the specification.

According to some embodiments, techniques are provided for determining if product element settings in a configuration file substantially match corresponding product element settings in a specification for the product and/or vice-versa. In at least some embodiments, element settings can refer to a behavior of an element, such as a display-related behavior, a network navigation behavior, a data processing behavior, and so on. For example, a behavior can include a navigation (e.g., via a hyperlink) to a particular network location such as a web page in a particular market indicated by a specification file and/or a configuration file. In at least some embodiments, determining whether or not product element settings match between a configuration file and a specification file can include determining if one or more behaviors associated with the product element are substantially similar.

In an example implementation scenario, a specification for a particular product can indicate that a text element of a user interface for the product is to be disabled in a marketized version of the product. Techniques discussed herein enable a configuration file setting for the text element determined from the marketized version of the product to be compared with the setting indicated in the specification (i.e., “disabled”) to determine if the two settings match. Results of this comparison can then be output, e.g., a “pass” indication if the settings match or a “fail” indication if the settings do not match. If the settings do not match, corrections can be made to the marketized product (e.g., via the configuration file) so that the marketized product matches the specification.

In at least some embodiments, techniques are provided for generating a specification from a configuration file for a marketized version of a product. For example, the configuration file can be associated with a version of the product that has already been released into a market, e.g., that is for sale in the market. In an example implementation, the configuration file for the marketized product is analyzed and elements and element settings from the configuration file are used to generate a specification file for the marketized version of the product. The specification file can then be used to validate the product and/or other versions of the product, e.g., subsequent builds and/or marketizations of the product. In at least some embodiments, the specification file can be updated based on a subsequent build of the product (e.g., to reflect updated elements and/or element settings) and then used to validate the subsequent build of the product.

In the discussion that follows, a section entitled “Operating Environment” is provided and describes one environment in which one or more embodiments can be employed. Following this, a section entitled “Example User Interfaces” describes example user interfaces that can be used to implement techniques discussed herein in accordance with one or more embodiments. Next, a section entitled “Example Methods” describes example methods in accordance with one or more embodiments. Following this, a section entitled “Example Reader Module Creation” discusses example techniques for creating reader modules in accordance with one or more embodiments. Last, a section entitled “Example System” describes an example system that can be utilized to implement one or more embodiments.

Operating Environment

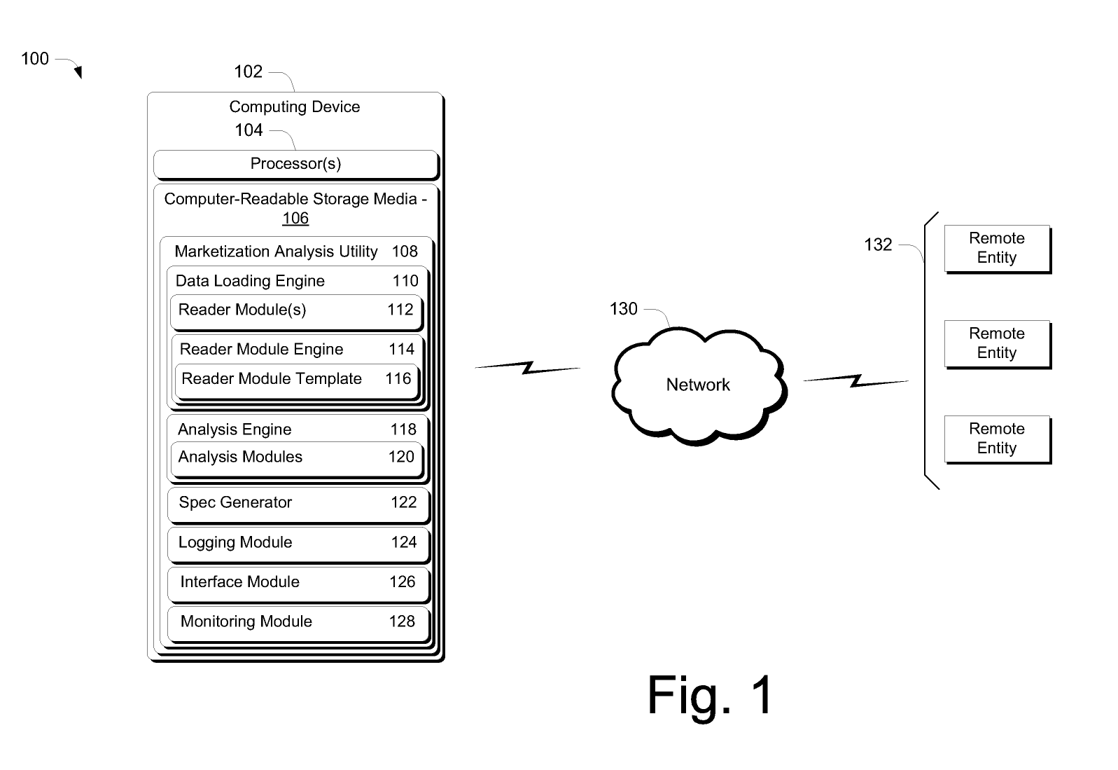

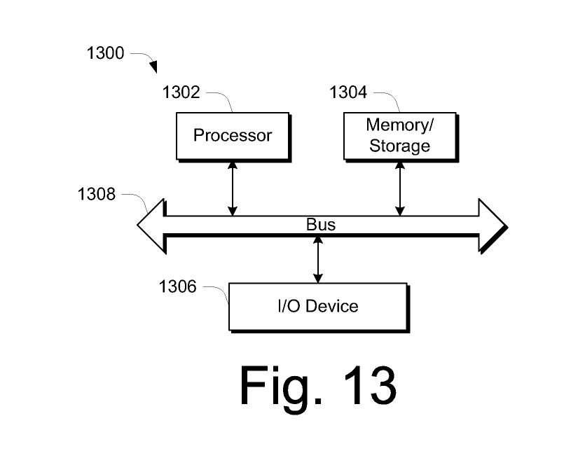

FIG. 1 illustrates an operating environment in accordance with one or more embodiments, generally at 100. Environment 100 includes a computing device 102 having one or more processors 104 and one or more computer-readable storage media 106. The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 13.

In addition, computing device 102 includes a module in the form of a marketization analysis utility 108 that can be implemented to verify marketization-related data and to generate marketization statistics and specification data. The marketization analysis utility (MAU) includes a data load engine 110 that can be utilized to load data from a variety of sources and in a variety of different formats. The data load engine includes and/or makes use of one or more reader modules 112 and a reader module engine 114. According to some embodiments, the reader modules can be implemented to interpret files that are loaded by the data load engine, such as configuration files and specification files. In at least some embodiments, individual reader modules of the reader modules 112 can be associated with different file formats which can enable the MAU to load, interpret, and analyze data in a variety of formats. Examples of file formats that can be supported by individual reader modules include XML and/or other markup languages, text files, spreadsheet files, resource files, and so on. In at least some example embodiments, the reader modules can be embodied as plug-ins that interface with the data load engine and/or the MAU to support a variety of file formats and/or products.

In at least some embodiments, the reader module engine 114 can be implemented to generate a reader module, e.g., as part of the reader modules 112. In an example implementation, the reader module engine can utilize a reader module template 116 to generate a reader module. For example, the reader module template can include a variety of data types, parameters, values, and/or settings. To generate a reader module for a specific file format and/or product, the reader module template can be instantiated and the data types, parameters, values, and or/settings can be adjusted for the particular file format and/or product. Generation of reader modules is discussed in more detail below.

The MAU also includes an analysis engine 118 that includes or makes use of one or more analysis modules 120. In at least some embodiments, the analysis engine can be implemented to analyze product element settings in a configuration file and/or a specification file. According to some embodiments, individual analysis modules of the analysis modules 120 can include computer code that is configured to analyze particular element types, such as user interface features, hyperlinks, data sources, and so on. Thus, the analysis engine can make use of a particular analysis module to analyze specific element types in a configuration file and/or a specification file for a product.

In an example implementation scenario, a particular analysis module of the analysis modules 120 is associated with a type of user interface control. To validate an instance of the user interface control for a particular product, the analysis engine can utilize the particular analysis module to compare the settings for the user interface control between a spec file for the product and a configuration file for the product. In at least some embodiments, an analysis module can also be customized for a particular product and/or version of a product to enable customized product and/or product configuration file analysis to be done.

The MAU also includes a specification generator 122 and a logging module 124. In at least some embodiments, the specification generator is configured to generate a specification file for a product. In an example implementation scenario, the specification generator can determine product elements and product element settings from a configuration file for a product. The specification generator can then generate a specification file that includes the product elements and the product element settings.

In at least some embodiments, the logging module 124 can log various information associated with the MAU, such as the results of an analysis of a configuration file and/or a specification file, a specification that is generated by the specification generator 122, and so on.

Also included as part of the MAU is an interface module 126 and a monitoring module 128. In at least some embodiments, the interface module 126 is configured to generate and/or interact with various types of interfaces to accomplish various tasks associated with the MAU. Examples of interfaces include a graphical user interface, a command line interface, and so on.

According to some embodiments, the monitoring module 128 is configured to detect events associated with the MAU and to report events to components of the MAU and/or other external entities. For example, the monitoring module can receive an indication of an update to an element for a particular product and can notify the specification generator 122 of the update. The specification generator can then retrieve information associated with the update and generate an updated specification file for the product that reflects the element update. In at least some embodiments, the monitoring module can also detect an update to a product specification file (e.g., a new element and/or an update to an element setting) and can cause a product configuration file to be updated based on the update to the product specification file. For example, the MAU can automatically cause a configuration file for a subsequent version of the product to be updated based on the update to the product specification file.

In addition, environment 100 includes a network 130, such as the Internet, and one or more remote entities 132 with which the MAU can communicate. Examples of the remote entities 132 include a remote web server, a cloud computing resource, and so on. In some example embodiments, the MAU can retrieve specification files and/or configuration files from the remote entities. Further to some embodiments, the MAU can report marketization analysis results and/or transmit a generated specification file to the remote entities.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of example user interfaces in accordance with one or more embodiments.

Example User Interfaces

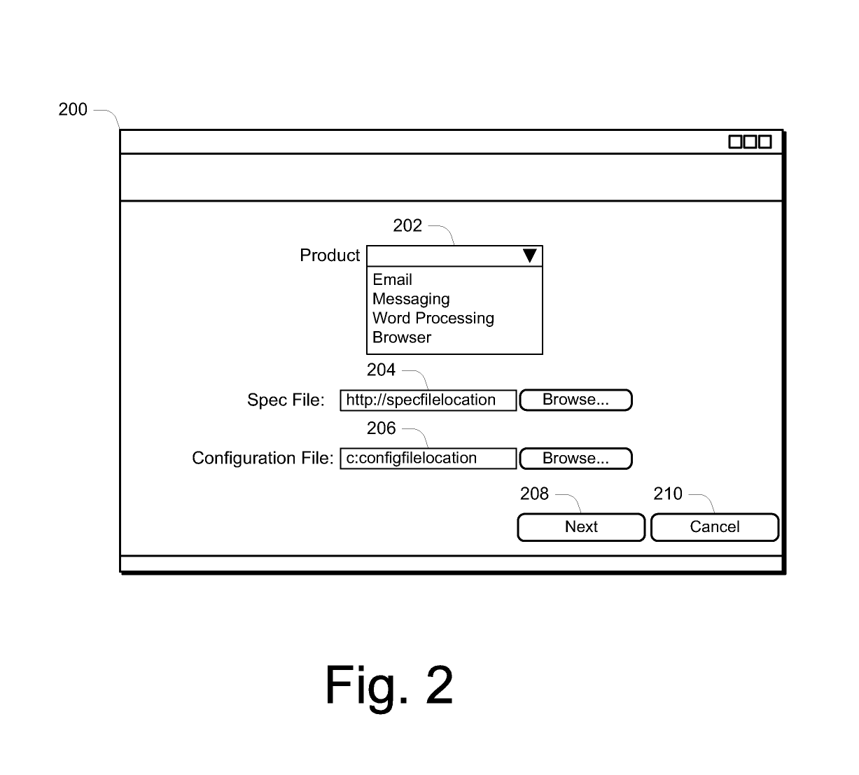

FIG. 2 illustrates an example graphical user interface (GUI) that can be used to implement techniques discussed herein in accordance with one or more embodiments, generally at 200. In at least some embodiments, the GUI 200 can be generated by the interface module 126 to perform various tasks associated with the MAU. According to some embodiments, GUI 200 can be associated with a wizard application that enables a user to perform various techniques and process discussed herein.

GUI 200 includes a product menu 202 which can be used to select a product to be analyzed and/or a product for which a spec file is to be generated. The GUI 200 also includes a specification file field 204 and a configuration file field 206. In at least some embodiments, the specification file field can be used to specify a location (e.g., a memory location or a network location) where a specification file for a particular product can be found. Also in some embodiments, the configuration file field 206 can be used to specify a location where a configuration file for a product can be found. According to one or more embodiments, the specification file field and/or the configuration file field can be automatically populated when a product is selected, e.g., via the product menu 200. Alternatively or additionally, a user can manually enter a location into the specification file field and/or the configuration file field, or the user can press the “browse” buttons (undesignated) associated with each of the fields to browse to a file or network location for a specification file and/or a configuration file.

Also included as part of the GUI 200 are a next button 208 and a cancel button 210. In at least some embodiments, the next button 208 can be pressed to navigate to a different user interface to accomplish different tasks and/or to provide further information as part of a particular task. The cancel button 210 can be pressed to cancel a current task (e.g., an analysis task being performed by the MAU) and/or to close the GUI 200.

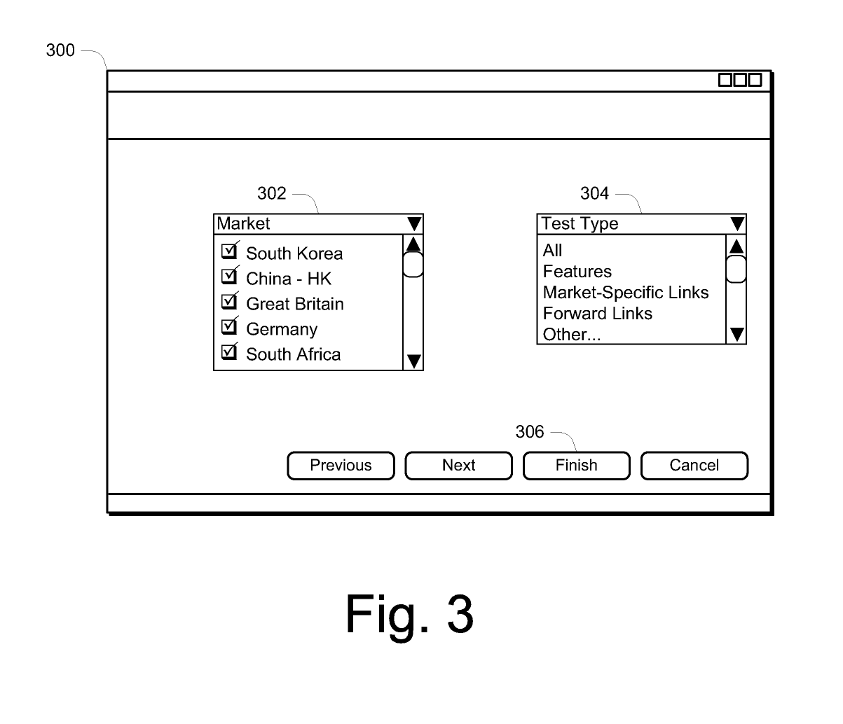

FIG. 3 illustrates an example graphical user interface (GUI) that can be used to implement techniques discussed herein in accordance with one or more embodiments, generally at 300. In at least some embodiments, the GUI 300 can be generated by the interface module 126 to perform various tasks associated with the MAU. In at least some embodiments, GUI 300 can be associated with a wizard application (e.g., in combination with GUI 200) that enables a user to perform various techniques and process discussed herein.

GUI 300 includes a market field 302 and a test type field 304. In at least some embodiments, the market field can be used to specify a market to be used for a particular analysis and/or specification generation. Also in some embodiments, the test type field 304 can be used to specify particular product elements and/or element types to be utilized and/or analyzed in a particular task. In some example embodiments, if a test type is not selected in the test type field 304, a default setting can indicate that all element types are to be utilized in performing an associated task.

Also included as part of GUI 300 is a finish button 306 that can be pressed to cause a particular task associated with the GUI 300 to be performed and/or completed. For example, pressing the finish button can cause a specification file and a configuration file selected via the GUI 200 (discussed above in FIG. 2) to be analyzed based on a market selected via the market field 302 and a test type selected via the test type field 304.

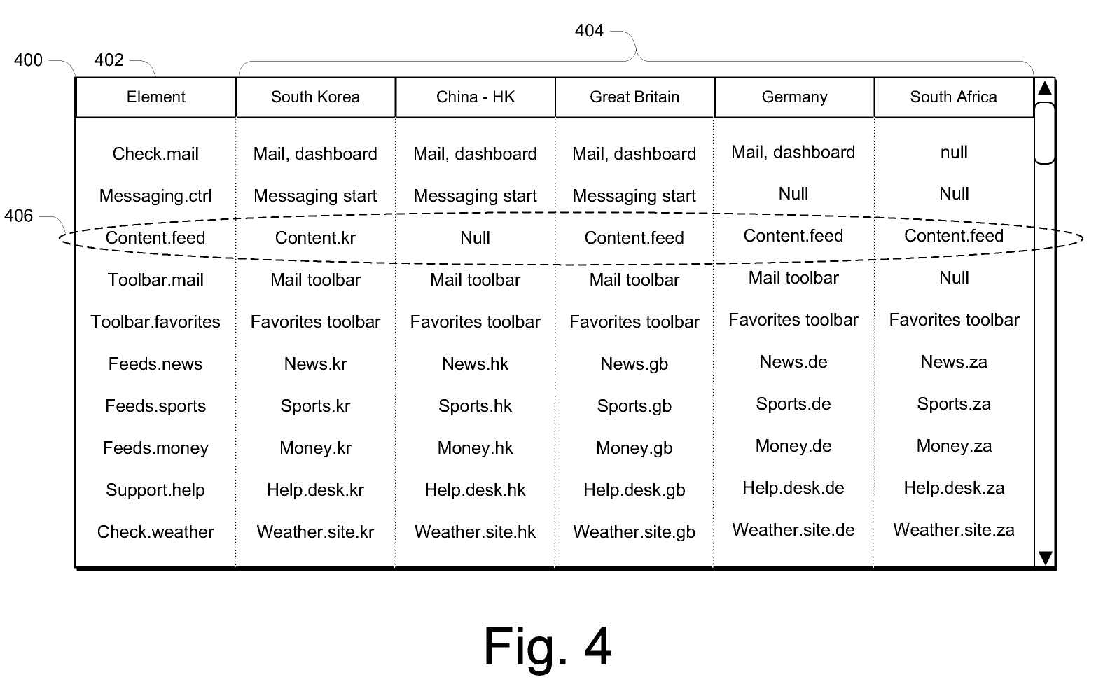

FIG. 4 illustrates an example settings table that can display a variety of product element settings in accordance with one or more embodiments, generally at 400. In at least some embodiments, the settings table 400 can include element settings from a configuration file and/or a specification file for a product. In an example implementation, the settings table can be output by the logging module 124 as a result of an analysis of a product by the MAU, e.g., via the data loading engine 110 and/or the analysis engine 118.

Settings table 400 includes an element column 402 and market columns 404. In at least some embodiments, the element column can list a variety of different elements for a product, such as elements determined from a configuration file and/or a specification file for the product. According to some embodiments, each of the market columns 404 can be associated with a different market. A particular market column of the market columns 404 can include values and/or settings for an element of the elements column 402 and for a particular market. For example, the first column of the market columns 404 includes element values for the South Korea market.

In an example implementation of the settings table 400, consider an element 406 that includes the “Content.feed” element and values for the element for each of the listed markets. As illustrated, each of the markets represented in the market columns 404 include a value for the “Content.feed” element except for the “China-HK” market, which is indicated as null. In at least some embodiments, a null value for an element can indicate that the element is disabled and/or does not exist for the particular market. Elements can be disabled for a particular market for a variety of reasons, such as financial considerations, demographic considerations, legal and/or political considerations, and so on.

As illustrated in the South Korea market column of element 406, the value for the “Content.feed” element has been customized to “Content.kr,” a resource associate with the Korean market, e.g., a Korean website. In at least some embodiments, elements can be customized for a particular market to provide market-specific settings, such as settings that retrieve market-specific content for a product.

Although not expressly illustrated in FIG. 4, in at least some embodiments the settings table 400 can include a fallback column that includes fallback settings and/or values for the elements of the element column 402. Fallback settings and fallback content are discussed in more detail below.

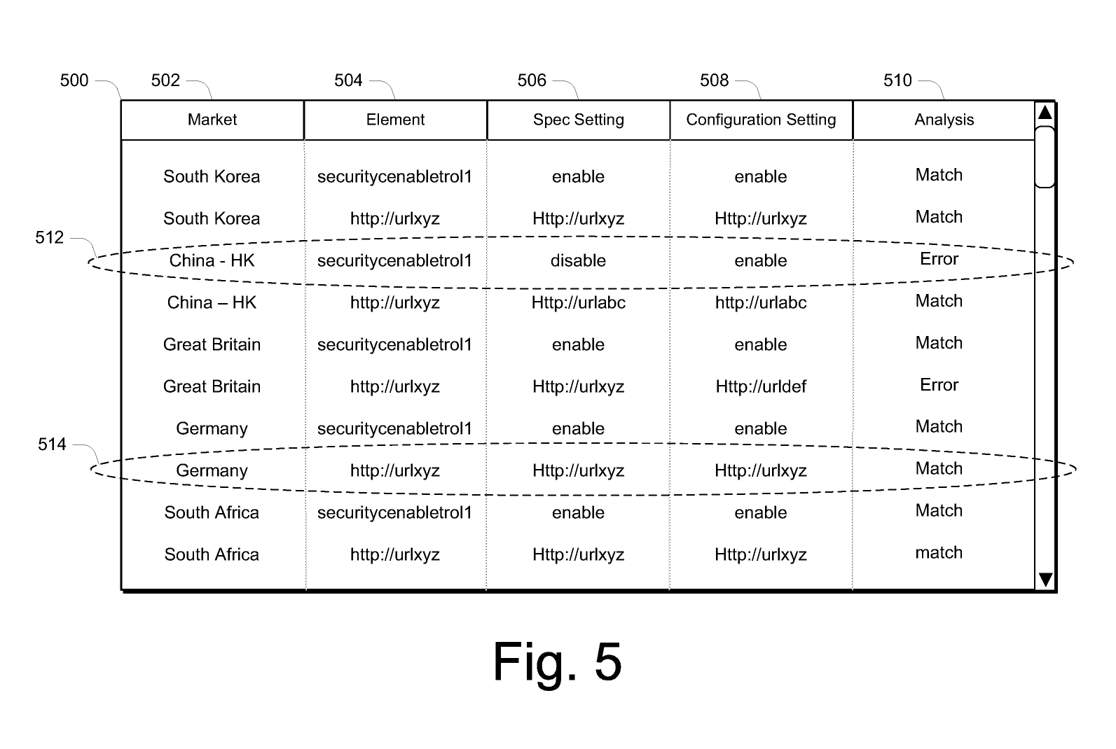

FIG. 5 illustrates an example analysis table that can display a variety of analysis results in accordance with one or more embodiments, generally at 500. In at least some embodiments, the analysis table 500 can be generated by the MAU (e.g., by the logging module 124) as a result of an analysis of a configuration file and a specification file for a product.

The analysis table 500 includes a variety of columns, such as a market column 502, an element column 504, a specification setting column 506, a configuration setting column 508, and an analysis column 510. In at least some embodiments, the market column 502 includes a listing of markets associated with a particular analysis and the element column 504 includes a listing of elements associated with the analysis.

According to some embodiments, the specification setting column 506 indicates a setting in a product specification file for an element indicated in the element column 504 and for a particular market indicated in the market column 502. Also in some embodiments, the configuration setting column 508 indicates a setting in a product configuration file for an element indicated in the element column 504 and for a particular market indicated in the market column 502.

In at least some embodiments, the analysis column 510 includes analysis results for a particular product analysis. For example, the analysis results can be generated based on a comparison of the configuration settings from the configuration setting column 508 with the specification settings from the specification setting column 506. According to some embodiments, the analysis column can indicate that a configuration setting matches a specification setting for a particular element, as indicated by the term “match” in the analysis column. Alternatively, the analysis column can indicate that a configuration setting differs from a specification setting for a particular element.

Additionally or alternatively, the analysis column 510 can indicate that an element and/or an element setting is missing from a configuration file or a specification file. For example, if an element is detected as being included in the specification file but not in the configuration file (or vice-versa), the element can be flagged.

For example, consider an element 512 of the analysis table 500. As illustrated, the specification setting for element 512 is listed as “disable” to indicate that the element is to be disabled for a version of the element that is marketized for the “China-HK” market. The configuration setting for element 512, however, is listed as “enable,” indicating that the actual configuration of the element in the marketized version of the product is enabled. Thus, the value for the element 512 included in the analysis column 510 indicates an error since the specification setting value and the configuration setting value do not match. In at least some embodiments, errors can be flagged in the analysis table 500 and a worker can then correct the errors in a configuration file and/or a specification file for a particular product. In an example implementation scenario, the MAU can include and/or interact with one or more functionalities that can cause an error (e.g., a bug) that is detected as part of a resource analysis to be automatically repaired. For example, an error in a specification file and/or a configuration file can be automatically corrected by the MAU after it is detected by the MAU.

Although not expressly illustrated in FIG. 5, in at least some embodiments the analysis table 500 can include a fallback column that indicates fallback settings for the elements in the element column 504. According to some embodiments, a fallback setting can be used if there is a problem with a setting and/or value from the specification setting column 506 and/or the configuration settings column 508, such as a broken hyperlink, an invalid network location, or missing content. In an example implementation scenario, an element 514 of the analysis table 500 includes a specification setting and a configuration setting of “http://urlxyz,” which is a link to a website in the German market. Further to the example implementation scenario, the element 514 includes a fallback setting of “http://urlenglish” (not illustrated), which is an English-language website that can be used as a fallback setting if the German website is unavailable and/or if the link to the German website is broken or missing.

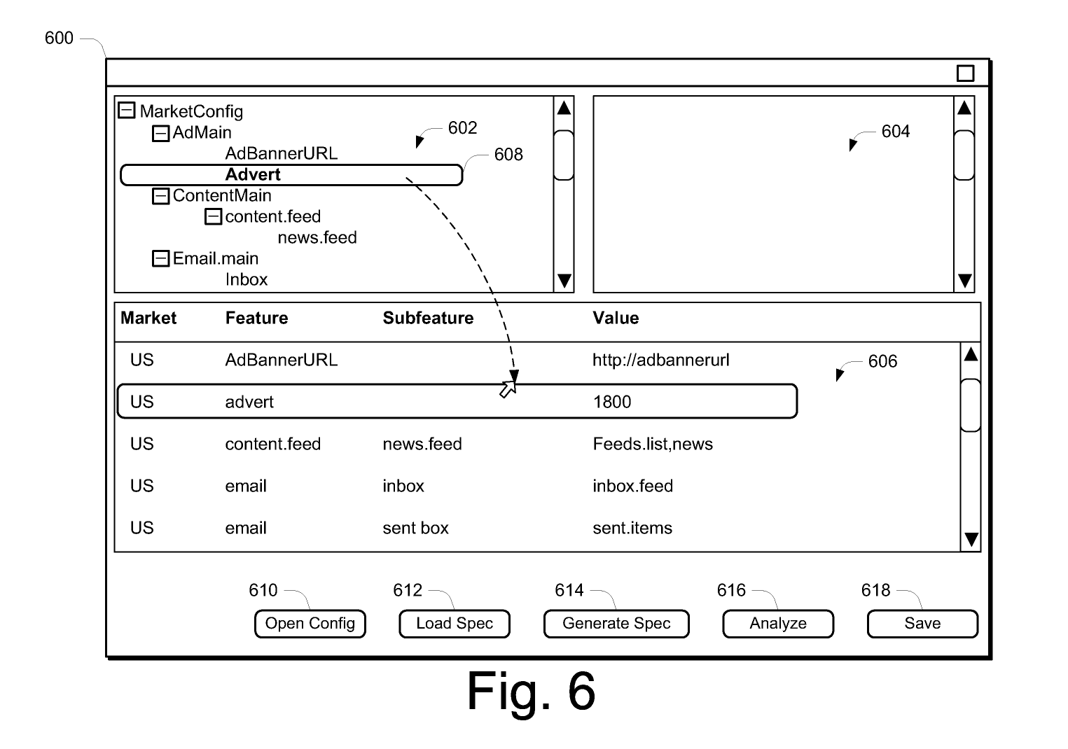

FIG. 6 illustrates an example graphical user interface (GUI) that can be used to implement techniques discussed herein in accordance with one or more embodiments, generally at 600. In at least some embodiments, the GUI 600 can be generated by the interface module 126 to perform various tasks associated with the MAU.

The GUI 600 includes a configuration file region 602, an element settings region 604, and a specification view region 606. In at least some embodiments, the configuration file region is configured to display elements associated with a product that are determined from a configuration file for the product. For example, a configuration file can be specified (e.g., via the GUI 200) and the configuration elements can be determined from the configuration file and displayed in the configuration file region. According to some embodiments, the element settings region 604 can display settings for configuration elements included in the configuration file region 602. The element settings region is discussed in more detail below.

In an example implementation scenario, consider a configuration element 608 that is highlighted in the configuration file region 602, e.g., in response to a user selection of the configuration element 608. In this example embodiment, the element settings region 604 is configured to display element settings for the configuration element 608. In at least some embodiments, element settings for a particular configuration element can be specified and/or changed via input to the configuration file region 602, the element settings region 604, and/or to the configuration element 608.

In at least some embodiments, the specification view region 606 can display elements and/or element settings that are to be included as part of a specification. For example, elements and/or element settings from the specification view region 606 can be used (e.g., by the specification generator 122) to generate a specification file for a product. According to some embodiments, a configuration element from the configuration file region 602 can be selected and copied to the specification view region 606 (e.g., via a drag-and-drop operation) to create and/or customize a specification file.

Also included as part of the GUI 600 are an open config button 610, a load spec button 612, a generate spec button 614, an analyze button 616, and a save button 618. In at least some embodiments, the open config button can be selected to open a configuration file for purposes of an analysis of the configuration file and/or for generating or editing a specification file. Also in some embodiments, the load spec button 612 can be selected to load a specification file.

According to some embodiments, the generate spec button 614 can be selected to generate a specification file. For example, actuating the generate spec button 614 can cause configuration elements and/or element settings from the specification view region 606 to be used to generate all or part of a specification file. In at least some embodiments, the analyze button 616 can be selected to analyze a configuration file and/or a specification file. For example, actuating the analyze button 616 can cause the GUI 200 (discussed above with reference to FIG. 2) to be displayed. Also in some embodiments, the save button 618 can be selected to save changes made via the element settings region 604, changes made to a specification file via the specification view region 606, and/or to generate a specification file based on elements and/or element settings indicated in the specification view region 606.

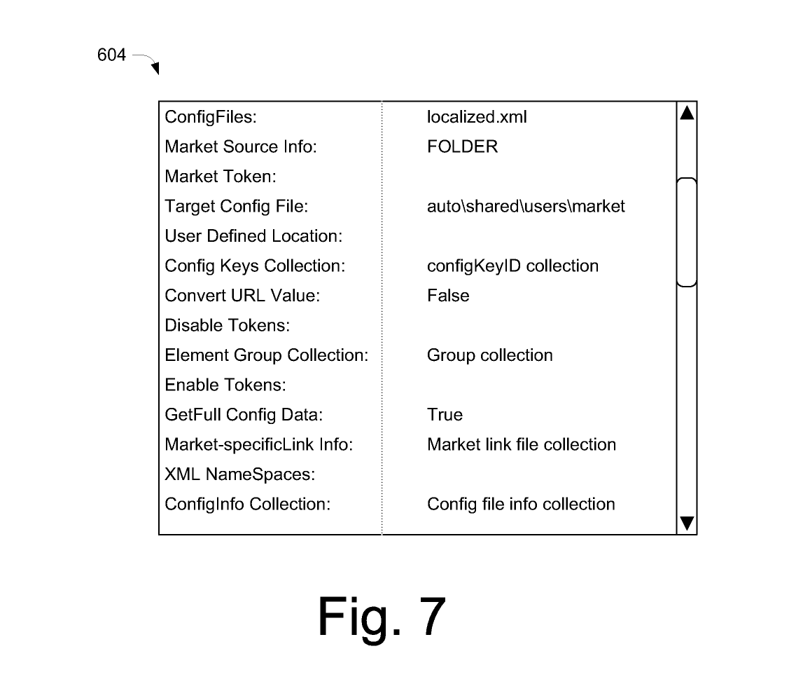

FIG. 7 illustrates the element settings region 604 in more detail in accordance with one or more embodiments. As illustrated, the element settings region can display various settings for an element and can be used to specify and/or customize particular element settings. In at least some embodiments, the element settings included in the element settings region are associated with the configuration element 608 and are displayed in response to a selection of and/or focus on the configuration element 608.

While various embodiments are discussed herein with reference to graphical user interfaces, additional or alternative embodiments can utilize a command line interface to implement various techniques discussed herein. For example, a command line interface can be utilized to invoke the MAU and its various components. In at least some embodiments, a configuration file and/or a specification file can be identified as part of the command line arguments, as well as a reader module that can be used to interpret the configuration file and/or the specification file. In at least some embodiments, the command line interface can enable various techniques discussed herein to be utilized in an “unattended” mode that does not require a user to be present during a particular analysis and/or process. According to some embodiments, once an analysis or other process begins in an unattended mode, no prompts are presented that require input from a user. Thus, a particular process or analysis can be run without interruption due to a requirement for user input.

Example Methods

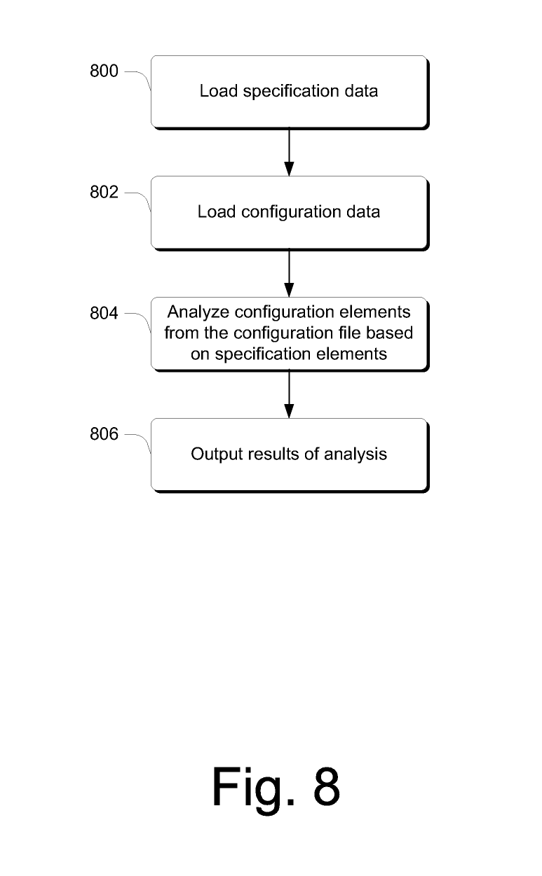

FIG. 8 is a flow diagram that describes steps a method in accordance with one or more embodiments. The method can be implemented in connection with any suitable hardware, software, firmware, or combination thereof. In at least some embodiments, the method can be implemented via a marketization analysis utility, such as the one described above.

Step 800 loads specification data. With reference to the operating environment 100, specification data can be loaded from a specification file obtained from a resource local to the computing device 102 and/or from a remote resource, such as the remote entities 132. Step 802 loads configuration data. Also with reference to the operating environment 100, configuration data can be loaded from a configuration file obtained from a resource local to the computing device 102 and/or from a remote resource, such as the remote entities 132. In at least some embodiments, a configuration file can include an indication of how marketization elements are stored in the configuration file, such as a schema for the configuration file that can enable configuration data from the configuration file to be interpreted. According to some embodiments, the order in which step 800 and step 802 occur can vary.

Step 804 analyzes configuration elements from the configuration file based on specification elements. In an example implementation scenario, a particular configuration element can be compared to a corresponding specification element to determine if the settings (e.g., enabled, disabled, or customized) for the two elements match. Additionally or alternatively, in some embodiments a particular specification element can be compared to a corresponding configuration element to determine if the settings for the two elements match, e.g., as part of a specification validation process.

According to some embodiments, analyzing elements from a configuration file and a specification file can include pattern and/or type matching. For example, if a value for a configuration element setting includes numbers but a value for a corresponding specification element setting is text, the configuration element can be flagged as having a possible error. As another example, if a configuration element setting is a URL but a value for a corresponding specification element setting is a GUI feature, the configuration element can be flagged as having a possible error.

Step 806 outputs the results of the analysis. Continuing the previous example implementation scenario, if the settings for the particular configuration element and the corresponding specification element do not match, the elements and/or elements settings can be flagged. According to some embodiments, if errors are detected in a configuration file and/or a specification file, the errors can be reported to a bug filer which can be used to correct the errors. In at least some embodiments, the results of the analysis can be displayed graphically, such as via the analysis table 500. Additionally or alternatively, in some embodiments the results of the analysis can be exported to a spreadsheet application.

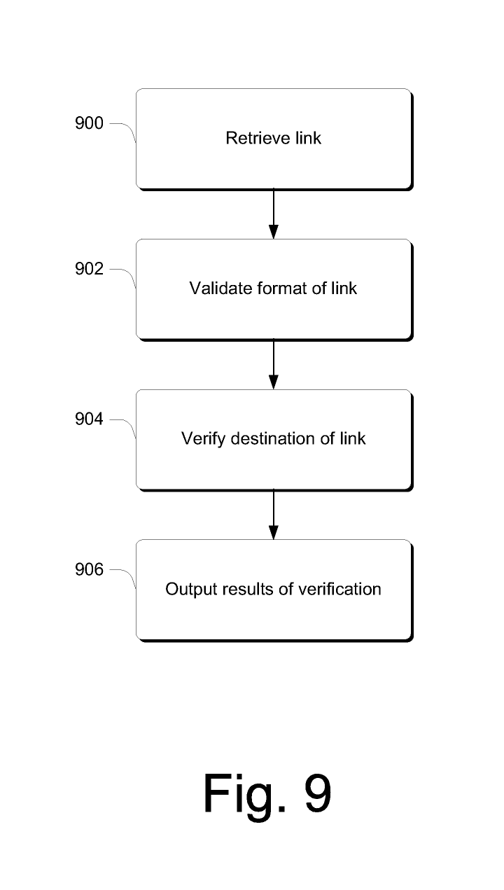

FIG. 9 is a flow diagram that describes steps a method in accordance with one or more embodiments. The method can be implemented in connection with any suitable hardware, software, firmware, or combination thereof. In at least some embodiments, the method can be implemented via a marketization analysis utility, such as the one described above.

Step 900 retrieves a link. In at least some embodiments, a variety of different types of links can be utilized, such as hyperlinks, forward links, market-specific links, and so on. According to some embodiments, a forward link refers to a link that redirects to a different location when selected, such as a location that is different from a web page via which the forward link is selected. Also in some embodiments, a market-specific link includes a URL that can be customized for a variety of different markets. According to some embodiments, the forward link and/or the market-specific link can be retrieved (e.g., via the data load engine 110) from a configuration file or a specification file for a particular product.

Step 902 validates the format of the link. For example, a market-specific link can be analyzed to determine if it includes an indication of the correct market for the market-specific link and a reference to a correct server for the market-specific link. Step 904 verifies the destination of the link. In at least some embodiments and with reference to operating environment 100, the analysis engine 118 can navigate to a destination (e.g., a web page) indicated by the link and determine if the destination is correct, e.g., that it matches a destination and/or market specified in a specification file according to a primary value or a fallback value. Also in some embodiments, the analysis engine can determine if the destination indicated by the link is valid, e.g., that a navigation to the destination does not return an error.

Step 906 outputs results of the verification. In at least some embodiments, the results of the verification can include results from step 902 (e.g., an indication of an incorrect market parameter and/or an incorrect server) and/or step 904, e.g., an indication that the link causes a navigation to a wrong location, a location in a wrong market, and/or that a location (e.g., a web page) indicated by the link is invalid.

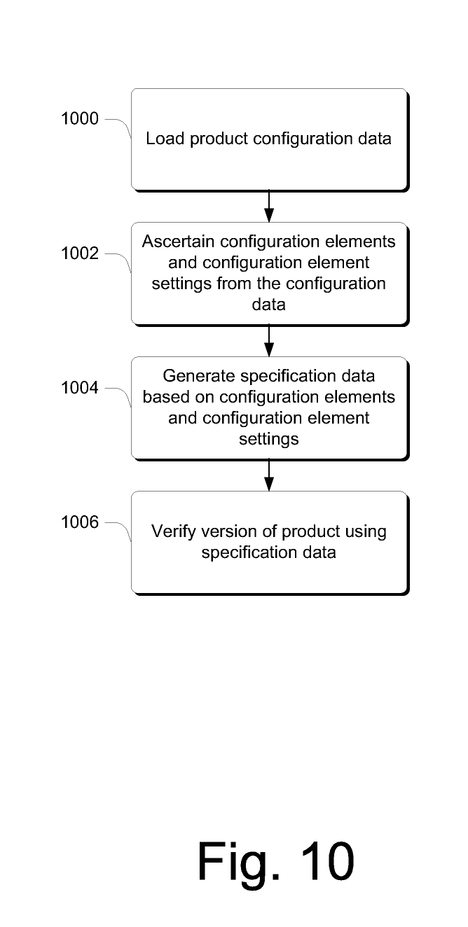

FIG. 10 is a flow diagram that describes steps a method in accordance with one or more embodiments. The method can be implemented in connection with any suitable hardware, software, firmware, or combination thereof. In at least some embodiments, the method can be implemented via a marketization analysis utility and/or via the GUI 600, described above.

Step 1000 loads product configuration data. In at least some embodiments, configuration data can include elements associated with an existing version of a product, e.g., a software application. For example, the configuration data can be loaded from a publically-released (e.g., for sale) version of a product. Step 1002 ascertains configuration elements and configuration element settings from the configuration data.

Step 1004 generates specification data based on the configuration elements and the configuration element settings. For example, some or all of the configuration data can be copied to create a specification file. Alternatively or additionally, configuration elements and/or settings can be selected by a user (e.g., via the GUI 600) to be used to generate the specification file.

Step 1006 verifies a version of the product using the specification data. For example, a specification file generated from the specification data can be used to verify a version of a product. Example techniques for verifying a specification file and/or a configuration file are discussed above.

In at least some embodiments, after a specification file is generated (e.g., at step 1004), the specification file can be updated for a subsequent version of the product. For example, elements and/or marketization content in the specification file can be added, deleted, and/or updated to reflect settings and/or content for the subsequent version of the product. After the subsequent version of the product is built, the updated specification can be used to verify the subsequent version of the product. For example, a configuration file for the subsequent version can be compared to the updated specification file to check if element settings and/or marketization content from the configuration file match those in the updated specification file. Example techniques for analyzing configuration files and/or specification files are discussed above in accordance with at least some embodiments.

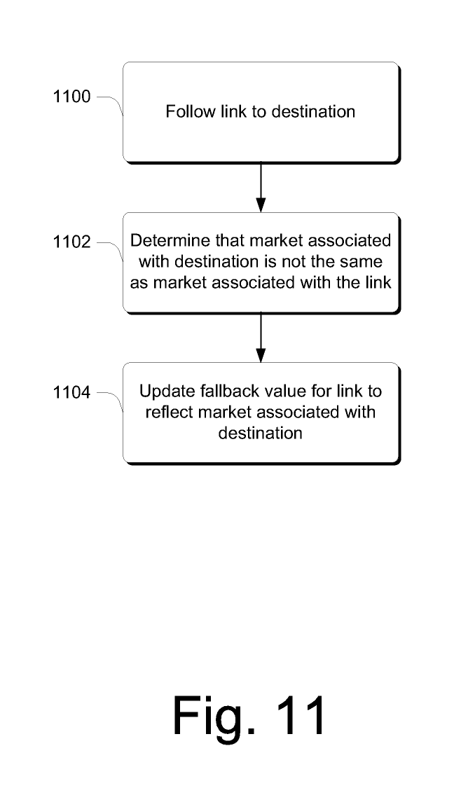

FIG. 11 is a flow diagram that describes steps a method in accordance with one or more embodiments. The method can be implemented in connection with any suitable hardware, software, firmware, or combination thereof. In at least some embodiments, the method can be implemented via a marketization analysis utility, such as the one described above.

Step 1100 follows a link to a destination. For example, a web browser can navigate to a network destination (e.g., website) associated with a URL indicated by the link. In at least some embodiments, the link can include a forward link and/or a market-specific link. For example, in some embodiments following the link to the destination can include a redirection to a different domain and/or market. Step 1102 determines that a market associated with the destination is not the same as a market associated with the link. For example, the link can include a market parameter for a first market (e.g., Arabic) and the destination can include a market parameter for a second, different market, e.g., English.

Step 1104 updates a fallback value for the link to reflect the market associated with the destination. As discussed above, a fallback value can provide a fallback setting (e.g., a URL) for a particular configuration and/or specification element. For example, in some embodiments a link can include a primary setting and a fallback setting. The primary setting can indicate a first destination (e.g., a first URL) to be used for a navigation behavior associated with the link. The fallback setting can indicate a second destination to be used for the navigation behavior if the first destination is not available and/or is not valid. With respect to links such as a forward link and/or a market-specific link, a fallback value can specify a URL or other address that can be navigated to if a primary URL or address is not available and/or is not valid. In at least some embodiments, the fallback value for an element can be included as part of the settings table 400 and/or the analysis table 500.

Having considered some example methods in accordance with one or more embodiments, consider now some example techniques for the creation of reader modules in accordance with one or more embodiments.

Reader Module Creation

As discussed above, in some embodiments a reader module can be utilized to interpret data from a configuration file and/or a specification file to enable the data to be used for various purposes, such as configuration file analysis, specification file analysis, specification file generation, and so on. In at least some embodiments, a particular reader module can be associated with a specific file format and/or a specific product and thus can enable files in the file format and/or for the specific product to be loaded and interpreted.

According to some embodiments, a reader module template can provide a common format upon which specific instances of a reader module can be created. In at least some embodiments, an XML schema can provide this common format. An example of such an XML schema is provided below:

Example Schema

<Product xmlns:xsi=“http://www.w3.org/2001/XMLSchema-instance”

xmlns:xsd=“http://www.w3.org/2001/XMLSchema” Name=“”>

<SpecSetting Type=“”>

...

</SpecSetting>
<ConfigSetting Type=“”>

...

</ConfigSetting>
<FeatureMap>

...

</FeatureMap>

</Product>

In at least some embodiments, this XML schema can be customized to create specific instances of a reader module. For example, the “Product” node can be used to specify a name for a particular product for which a reader module is being created. Additionally, “SpecSetting” and/or “ConfigSetting” can indicate file types associated with a specification file and/or a configuration file for the product. In at least some embodiments, “FeatureMap” can be used to map elements from a specification file for the product to elements from a configuration file for the product.

One example of a reader module that utilizes this particular schema is provided below in accordance with one or more embodiments.

Example Reader Module

<Product xmlns:xsi=“http://www.w3.org/2001/XMLSchema-instance”
xmlns:xsd=“http://www.w3.org/2001/XMLSchema” Name=“Skydrive-
Service”>

<SpecSetting Type=“MS.GPD.Tools.MAT.PluginBase.ExcelSetting”>

<ParamList>

<Param Name=“Location”>

<Value

xsi:type=“xsd:string”>http://sharepoint/sites/wlxintl/IntlWLX/SDX/Marketi
zation1/SkyDrive/SkyDrive_Marketization.xlsx</Value>

</Param>
<Param Name=“Worksheets”>

<Value xsi:type=“WorksheetCollection”>

<Collection>

<Worksheet WorksheetName=“sheet1” MarketColumn=“2”

DataRowStart=“2” HeaderRows=“1”/>

</Collection>

</Value>

</Param>
<Param Name=“EnableTokens”>

<Value xsi:type=“xsd:string”>Y</Value>

</Param>
<Param Name=“DisableTokens”>

<Value xsi:type=“xsd:string”>N;</Value>

</Param>

</ParamList>

</SpecSetting>
<ConfigSetting Type=“MS.GPD.Tools.MAT.PluginBase.XmlSetting”>

<ParamList>

<Param Name=“BuildFlavor”>

<Value xsi:type=“xsd:string”>debug</Value>

</Param>
<Param Name=“BuildNumber”>

<Value xsi:type=“xsd:string”>Latest</Value>

</Param>
<Param Name=“BuildRootPath”>

<Value

xsi:type=“xsd:string”>\\wlxbuilds\dropshare\sdx\working.sdx\drop</Value
>

</Param>
<Param Name=“BuildPrivatePath”>

<Value

xsi:type=“xsd:string”>Folders\i386\deployment\packages</Value>

</Param>
<Param Name=“ZipFile”>

<Value xsi:type=“xsd:string”>SkyWeb.zip</Value>

</Param>
<Param Name=“ZipInternalPath”>

<Value

xsi:type=“xsd:string”>Environments\current\tk2\LiveFolders</Value>

</Param>
<!--<Param Name=“UserDefinedLocation”>

<Value

xsi:type=“xsd:string”>F:\MarketizationToolDoc\SpecGeneration\ProductCo
nfig\Skydrive</Value>

</Param>-->
<Param Name=“ConfigFiles”>

<Value xsi:type=“xsd:string”>LiveFolders-

ServiceConfig.xml</Value>

</Param>
<Param Name=“DisableTokens”>

<Value xsi:type=“xsd:string”>false;0</Value>

</Param>
<Param Name=“EnableTokens”>

<Value xsi:type=“xsd:string”>true;1</Value>

</Param>
<Param Name=“MarketToken”>

<Value xsi:type=“xsd:string”>ll-cc</Value>

</Param>
<Param Name=“ConfigInfoCollection”>

<Value xsi:type=“ConfigFileInfoCollection”>

<Collection>

<Item FeatureConfigNodeName=“LiveFolders”

ConfigFile=“.+\\LiveFolders-ServiceConfig.xml” />

</Collection>

</Value>

</Param>
<Param Name=“MarketSourceInfo”>

<Value xsi:type=“xsd:string”>ENUMLIST;SIBLING</Value>

</Param>
<Param Name=“SupportedMarkets”>

<Value xsi:type=“MarketCollection”>

<Collection>

<Item Market=“en-au” Language=“en” LCID=“” />
<Item Market=“eu-es” Language=“eu” LCID=“” />
......

</Collection>

</Value>

</Param>

</ParamList>

</ConfigSetting>
<FeatureMap>

<Feature SpecKey=“Slideshow experience in Silverlight”

ConfigKey=“/config/block/LiveFolders/SilverlightSupportedMarket/Market
Suffix[(SIBLING):(MarketSuffix)](innerText − MarketSuffix)”
ValueTag=“”HostFile=“.+\\LiveFolders-ServiceConfig.xml”/>
...

</FeatureMap>

</Product>

Thus, in at least some embodiments, a variety of different reader modules can be utilized (e.g., by the MAU) to provide the ability to interpret files in a variety of different formats and/or for a variety of different products. Consider now an example method that can be utilized to implement one or more embodiments for generating a reader module.

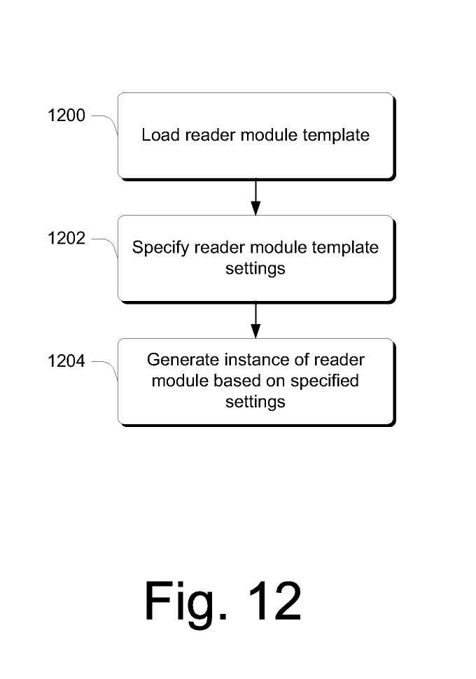

FIG. 12 is a flow diagram that describes steps a method in accordance with one or more embodiments. The method can be implemented in connection with any suitable hardware, software, firmware, or combination thereof. In at least some embodiments, the method can be implemented via an MAU, such as the one described above.

Step 1200 loads a reader module template. An example of a reader module template is provided above in accordance with one or more embodiments. Step 1202 specifies reader module template settings. For example, file type settings can be provided for a specification file and/or a configuration file, feature map settings can be specified for mapping elements from a specification file for a product to elements from a configuration file for the product, and so on.

Step 1204 generates an instance of a reader module based on the specified settings. In at least some embodiments, the reader module can be specific to a particular product and/or file type. In an example implementation scenario and with reference to the operating environment 100 discussed above, the reader module can be used by the reader module engine 114 to interpret a configuration file and/or a specification file associated with a particular product.

Having described rules that can be utilized in accordance with one more embodiments, consider now an example system that can be utilized to implement one or more embodiments.

Example System

FIG. 13 illustrates an example computing device 1300 that can be used to implement the various embodiments described above. Computing device 1300 can be, for example, computing device 102 and/or one or more of remote entities 132 of FIG. 1.

Computing device 1300 includes one or more processors or processing units 1302, one or more memory and/or storage components 1304, one or more input/output (I/O) devices 1306, and a bus 1308 that allows the various components and devices to communicate with one another. Bus 1308 represents one or more of any of several types of bus structures, including a memory bus or memory controller, a peripheral bus, an accelerated graphics port, and a processor or local bus using any of a variety of bus architectures. Bus 1308 can include wired and/or wireless buses.

Memory/storage component 1304 represents one or more computer storage media. Component 1304 can include volatile media (such as random access memory (RAM)) and/or nonvolatile media (such as read only memory (ROM), Flash memory, optical disks, magnetic disks, and so forth). Component 1304 can include fixed media (e.g., RAM, ROM, a fixed hard drive, etc.) as well as removable media (e.g., a Flash memory drive, a removable hard drive, an optical disk, and so forth).

One or more input/output devices 1306 allow a user to enter commands and information to computing device 1300, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide techniques for analyzing the marketization of products. In at least some embodiments, a marketized version of a product (e.g., a software application) is associated with a configuration file that indicates actual product element settings for the marketized version. According to some embodiments, techniques are provided for determining if the product element settings in the configuration file match product element settings in a specification for the product and/or vice-versa.

In at least some embodiments, techniques are provided for generating a specification file from a configuration file for a marketized version of a product. For example, product elements and product element settings can be selected from the configuration file and used to generate the specification file. The specification file can then be used to validate the product and/or other versions of the product, e.g., subsequent builds and/or marketizations of the product.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer readable storage media embodying computer readable instructions comprising:
a data load engine that is configured to load product marketization files in a plurality of different file formats;
a plurality of reader modules that are each configured to interpret one or more of the product marketization files to determine one or more element settings for elements of a product configuration file of the product marketization files; and
an analysis engine that is configured to analyze the one or more element settings of the product configuration file to determine if the one or more element settings of the product configuration file match one or more element settings of a product specification file.

2. The one or more computer readable storage media of claim 1, wherein the product comprises a software application.

3. The one or more computer readable storage media of claim 1, wherein the elements of the product configuration file comprise one or more of a product feature, a forward link, or a market-specific link.

4. The one or more computer readable storage media of claim 1, wherein the one or more element settings comprise one or more of enabled, disabled, or customized.

5. The one or more computer readable storage media of claim 1, wherein one or more of the reader modules comprise a plug-in that is configured to interface with one or more of the data load engine or the analysis engine.

6. The one or more computer readable storage media of claim 1, further comprising one or more of a command line interface or a graphical user interface that is configured to enable selection of one or more of the product configuration file or the product specification file.

7. The one or more computer readable storage media of claim 1, further comprising a user interface that is configured to display the one or more element settings of the product configuration file and the one or more element settings of the product specification file for a plurality of different markets.

8. The one or more computer readable storage media of claim 1, further comprising a specification generator module that is configured to generate the product specification file based at least in part on the one or more element settings for the elements of the product configuration file.

9. The one or more computer readable storage media of claim 8, further comprising a user interface that is configured enable selection of one or more of the elements of the product configuration file to be used to generate the product specification file.

10. A computer-implemented method comprising:
loading specification data and configuration data for a product; and
analyzing one or more configuration element settings of the configuration data to determine if the one or more configuration element settings substantially match one or more corresponding specification element settings of the specification data.

11. The computer-implemented method of claim 10, wherein the configuration data comprises one or more of marketization data or market-specific content associated with a marketized version of the product.

12. The computer-implemented method of claim 10, wherein the configuration element settings comprise settings for one or more of product features, market-specific content, or product hyperlinks.

13. The computer-implemented method of claim 10, wherein the one or more configuration element settings comprise one or more of enabled, disabled, or customized.

14. The computer-implemented method of claim 10, further comprising outputting a table that includes results of the analyzing, the results including an indication that one or more of the configuration element settings do not match one or more of the specification element settings.

15. The computer-implemented method of claim 10, further comprising:
validating a format of a market-specific link included as part of the configuration data; and
verifying that the market-specific link is configured to cause a navigation to a correct location.

16. A computer-implemented method comprising:
ascertaining configuration elements and settings for the configuration elements from a marketized version of a product; and
generating a specification for the product using the configuration elements and the settings for the configuration elements.

17. The computer-implemented method of claim 16, wherein ascertaining the configuration elements and the settings for the configuration elements is responsive to a selection of the configuration elements via one or more of a graphical user interface or a command line interface.

18. The computer-implemented method of claim 16, further comprising:
determining a fallback market for one or more of the configuration elements; and
updating a setting for the one or more of the configuration elements to reflect the fallback market.

19. The computer-implemented method of claim 16, further comprising:
generating an updated version of the specification based on one or more changes to the product indicated in a subsequent version of the product; and
verifying the subsequent version of the product using the updated version of the specification.

20. The computer-implemented method of claim 19, wherein the verifying determines an error in the subsequent version of the product and wherein the method further comprises causing a correction to the subsequent version of the product to be automatically made based on the error.
